(19) United States
(12) Patent Application Publication
(10) Pub. No.: US 2025/0330925 A1
(43) Pub. Date: Oct. 23, 2025

(54) ADAPTIVE SYNCHRONIZATION SIGNAL BLOCK OCCASION TO RANDOM ACCESS OCCASION MAPPING

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Hung Dinh LY, San Diego, CA (US)

(21) Appl. No.: 18/638,313

(22) Filed: Apr. 17, 2024

(51) Int. Cl. H04W 56/00; H04W 24/08; H04W 74/0833

(52) U.S. Cl. CPC H04W 56/0015; H04W 24/08; H04W 74/0833

(57) ABSTRACT

Methods, systems, and devices for wireless communications are described. A user equipment (UE) may receive signaling indicating a change in a quantity of one or more activated synchronization signal block (SSB) occasions in an SSB burst and may transmit a random access message via a random access occasion (RO) based on a mapping of the one or more activated SSB occasions to a plurality of ROs. In some cases, the mapping may adapt based to the change based on whether the change in the quantity of the one or more activated SSB occasions is an increase or a decrease. Additionally, the mapping may be based on a time durations elapsing after the UE receives the signaling. For example, the UE may apply, generate, receive, obtain, or reference the mapping after the time duration has elapsed since receiving the signaling.

### FIELD OF TECHNOLOGY

The following relates to wireless communications, including adaptive synchronization signal block occasion to random access occasion mapping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support adaptive synchronization signal block (SSB) occasion to random access occasion (RO) mapping. For example, the described techniques provide for a user equipment (UE) to receive signaling indicating a change in a quantity of one or more activated SSB occasions in an SSB burst and transmit a random access message via an RO based on a mapping (e.g., an adaptive mapping, a dynamic mapping) of the one or more activated SSB occasions to a plurality of ROs. In some cases, the mapping may adapt based on the type of change (e.g., increase, decrease) in the quantity of the one or more activated SSB occasions. Additionally, the mapping may be based on a time durations elapsing after the UE receives the signaling. For example, the UE may apply the mapping (e.g., determine the mapping, generate the mapping, update the mapping, reference the mapping) after the time duration has elapsed since receiving the signaling.

A method by a UE is described. The method may include receiving signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling, monitoring the set of multiple activated SSB occasions of the set of multiple SSB occasions of the SSB burst based on the signaling, and transmitting a random access message via a RO of the set of multiple ROs based on the set of multiple activated SSB occasions being monitored and the mapping.

A UE is described. The UE may include one or more memories storing processor executable code, and one or more processors coupled with the one or more memories. The one or more processors may individually or collectively be operable to execute the code to cause the UE to receive signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling, monitor the set of multiple activated SSB occasions of the set of multiple SSB occasions of the SSB burst based on the signaling, and transmit a random access message via a RO of the set of multiple ROs based on the set of multiple activated SSB occasions being monitored and the mapping.

Another UE is described. The UE may include means for receiving signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling, means for monitoring the set of multiple activated SSB occasions of the set of multiple SSB occasions of the SSB burst based on the signaling, and means for transmitting a random access message via a RO of the set of multiple ROs based on the set of multiple activated SSB occasions being monitored and the mapping.

A non-transitory computer-readable medium storing code is described. The code may include instructions executable by one or more processors to receive signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling, monitor the set of multiple activated SSB occasions of the set of multiple SSB occasions of the SSB burst based on the signaling, and transmit a random access message via a RO of the set of multiple ROs based on the set of multiple activated SSB occasions being monitored and the mapping.

In some examples of the method, UEs, and non-transitory computer-readable medium described herein, the signaling indicates to deactivate a first SSB occasion of the set of multiple activated SSB occasions and the mapping indicates that the first SSB occasion may be mapped to one of the set of multiple ROs based on the signaling.

In some examples of the method, UEs, and non-transitory computer-readable medium described herein, the signaling indicates to deactivate a first SSB occasion of the set of multiple activated SSB occasions and the mapping indicates that the RO may be mapped to a second SSB occasion of the set of multiple activated SSB occasions that may be temporally adjacent to the deactivated first SSB occasion within the SSB burst based on the signaling.

In some examples of the method, UEs, and non-transitory computer-readable medium described herein, the signaling indicates to deactivate a first SSB occasion of the set of multiple activated SSB occasions and the mapping indicates that the RO corresponds to the first SSB occasion, the first SSB occasion being monitored within a second SSB burst that occurs prior to deactivation of the first SSB occasion.

In some examples of the method, UEs, and non-transitory computer-readable medium described herein, the signaling indicates to deactivate a first SSB occasion of the set of multiple activated SSB occasions and the mapping excludes a second RO of the set of multiple ROs that corresponds to the first SSB occasion based on the signaling.

In some examples of the method, UEs, and non-transitory computer-readable medium described herein, the signaling indicates to activate a first SSB occasion of the set of multiple SSB occasions and the mapping associates each of the set of multiple activated SSB occasions except for the activated first SSB occasion with a respective RO of the set of multiple ROs based on the signaling.

In some examples of the method, UEs, and non-transitory computer-readable medium described herein, the signaling indicates to activate a first SSB occasion of the set of multiple SSB occasions and the mapping associates each of the set of multiple activated SSB occasions including the activated first SSB occasion with a respective RO of the set of multiple ROs based on the signaling.

In some examples of the method, UEs, and non-transitory computer-readable medium described herein, the signaling indicates to activate a first SSB occasion of the set of multiple SSB occasions, the random access message includes a first preamble of a first subset of preambles of a set of multiple preambles associated with the RO, and the first subset of preambles corresponds to the activated first SSB occasion and a second subset of preambles of the set of multiple preambles corresponds to a second SSB occasion of the set of multiple activated SSB occasions.

Some examples of the method, UEs, and non-transitory computer-readable medium described herein may further include operations, features, means, or instructions for receiving second signaling indicating the second SSB occasion of the set of multiple activated SSB occasions may be associated with preamble partitioning of the set of multiple preambles.

In some examples of the method, UEs, and non-transitory computer-readable medium described herein, the mapping may be based on a time duration from reception of the signaling elapsing and the time duration may be a fixed time duration, may be indicated to the UE via the received signaling, may be indicated to the UE via RRC signaling, or any combination thereof.

Some examples of the method, UEs, and non-transitory computer-readable medium described herein may further include operations, features, means, or instructions for receiving a SIB after reception of the signaling, where the mapping may be applied based on reception of the SIB.

### BRIEF DESCRIPTION OF THE DRAWINGS

FIG. 1 shows an example of a wireless communications system that supports adaptive synchronization signal block (SSB) occasion to random access occasion (RO) mapping in accordance with one or more aspects of the present disclosure.

FIG. 2 shows an example of a wireless communications system that supports adaptive SSB occasion to RO mapping in accordance with one or more aspects of the present disclosure.

FIG. 3 shows an example of a resource correspondence diagram that supports adaptive SSB occasion to RO mapping in accordance with one or more aspects of the present disclosure.

FIG. 4 shows an example of a resource correspondence diagram that supports adaptive SSB occasion to RO mapping in accordance with one or more aspects of the present disclosure.

FIG. 5 shows an example of a process flow that supports adaptive SSB occasion to RO mapping in accordance with one or more aspects of the present disclosure.

FIGS. 6 and 7 show block diagrams of devices that support adaptive SSB occasion to RO mapping in accordance with one or more aspects of the present disclosure.

FIG. 8 shows a block diagram of a communications manager that supports adaptive SSB occasion to RO mapping in accordance with one or more aspects of the present disclosure.

FIG. 9 shows a diagram of a system including a device that supports adaptive SSB occasion to RO mapping in accordance with one or more aspects of the present disclosure.

FIG. 10 shows a flowchart illustrating methods that support adaptive SSB occasion to RO mapping in accordance with one or more aspects of the present disclosure.

### DETAILED DESCRIPTION

In some wireless communications systems, a user equipment (UE) may transmit a random access message via a random access occasion (RO) to a network entity in order to establish (e.g., continue, reestablish) a connection with the network entity. In some cases, the UE may select the RO from a plurality of ROs that are mapped to a plurality of synchronization signal block (SSB) occasions within an SSB burst. For example, the plurality of SSB occasions may be indicated to the UE via system information (e.g., a system information block (SIB), SIB1, SSB-PositionsInBurst). In some cases, the UE may measure one or more SSBs transmitted via the one or more SSB occasions, and may select an RO corresponding to an SSB occasion associated with the highest measurement. In some cases, the network entity and the UE may reduce power consumption by communicating fewer SSBs. However, changing a quantity of one or more activated SSB occasions (e.g., SSB occasions in the SSB burst that the network entity actually uses to transmit SSBs) within the SSB burst may result in an unclear mapping for the UE between the resulting one or more activated SSB occasions and the plurality of ROs. Thus, techniques for dynamically updating a quantity of the one or more activated SSB occasions of an SSB burst and dynamically mapping the one or more activated SSB occasions to the plurality of ROs may be beneficial.

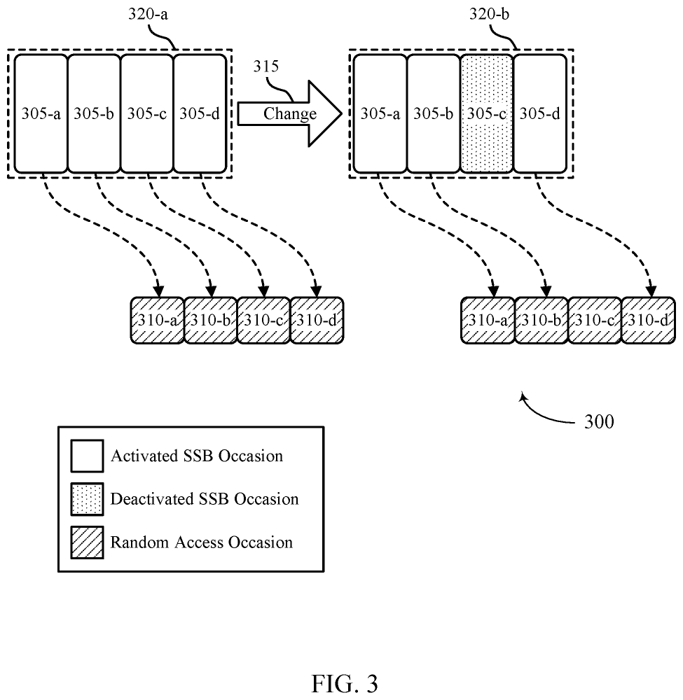

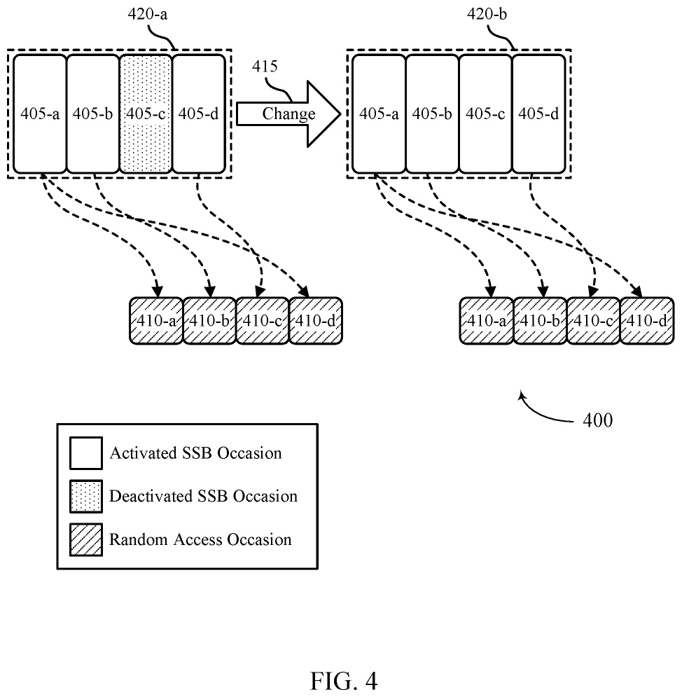

According to techniques described herein, a UE may receive signaling indicating a change in a quantity of one or more activated SSB occasions in an SSB burst and transmit a random access message via an RO based on a mapping (e.g., an adaptive mapping, a dynamic mapping) of the one or more activated SSB occasions to a plurality of ROs. In some cases, the mapping may adapt based on the type of change in the quantity of the one or more activated SSB occasions. For example, if the quantity decreases, the mapping may adapt in one or more ways (as described herein with respect to FIG. 3), and if the quantity increases, the mapping may adapt in one or more other ways (e.g., as described herein with respect to FIG. 4). Additionally, the mapping may be based on a time durations elapsing after the UE receives the signaling. For example, the UE may apply the mapping (e.g., determine the mapping, generate the mapping, update the mapping, reference the mapping) after the time duration has elapsed since receiving the signaling. In some cases, the time duration may be a fixed time duration (e.g., in one or more standards documents), the UE may receive an indication of the time duration via the signaling or via RRC signaling, or any combination thereof. Additionally, or alternatively, the time duration may elapse based on the UE receiving a SIB after reception of the signaling.

As used herein, an activated SSB occasion may refer to an SSB occasion within an SSB burst via which a network entity may transmit (e.g., broadcast) an SSB (e.g., an SSB occasion within the SSB burst that may carry an SSB). Additionally, or alternatively, a deactivated SSB occasion may refer to an SSB occasion within an SSB burst via which a network entity may not transmit (e.g., not broadcast) an SSB (e.g., an SSB occasion within the SSB burst that may not carry an SSB). An SSB occasion may refer to a set of time and frequency resources associated with communication of SSBs, and an RO may refer to a set of time and frequency resources associated with communication of random access messages (e.g., a MsgA for two step random access, a Msg 1 for four step random access). Additionally, as used herein, the term “mapping” may refer to an SSB occasion to RO mapping.

Aspects of the disclosure are initially described in the context of wireless communications systems. Aspects of the disclosure are also described with respect to signaling occasion correspondence diagrams and process flows. Aspects of the disclosure are further illustrated by and described with reference to apparatus diagrams, system diagrams, and flowcharts that relate to adaptive SSB occasion to RO mapping.

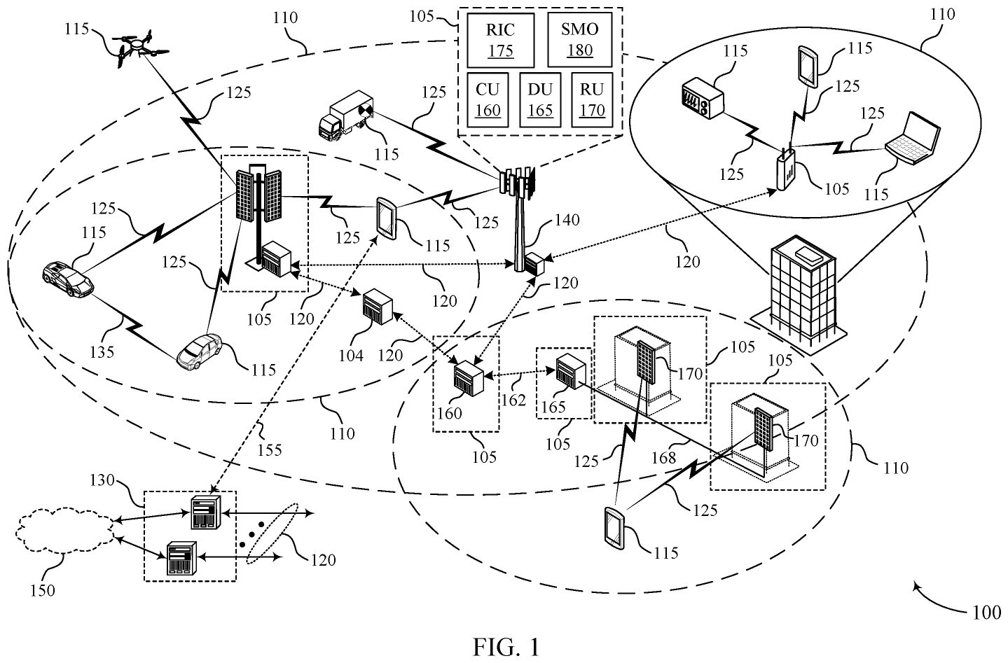

FIG. 1 shows an example of a wireless communications system 100 that supports adaptive SSB occasion to RO mapping in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

According to techniques described herein, a UE 115 may receive signaling that indicates a change in a quantity of one or more activated SSB occasions in an SSB burst. The UE 115 may monitor the one or more activated SSB occasions and transmit a random access message via an RO based on a mapping (e.g., an adaptive mapping, a dynamic mapping) of the one or more activated SSB occasions to a plurality of ROs. In some cases, the mapping may adapt based on the type of change in the quantity of the one or more activated SSB occasions. For example, if the quantity decreases, the mapping may adapt in one or more ways (as described herein with respect to FIG. 3), and if the quantity increases, the mapping may adapt in one or more other ways (e.g., as described herein with respect to FIG. 4). Additionally, the mapping may be based on a time durations elapsing after the UE 115 receives the signaling. For example, the UE 115 may apply the mapping (e.g., determine the mapping, generate the mapping, update the mapping, reference the mapping) after the time duration has elapsed since receiving the signaling. In some cases, the time duration may be a fixed time duration (e.g., in one or more standards documents), the UE 115 may receive an indication of the time duration via the signaling or via RRC signaling, or any combination thereof. Additionally, or alternatively, the time duration may elapse based on the UE receiving a SIB after reception of the signaling.

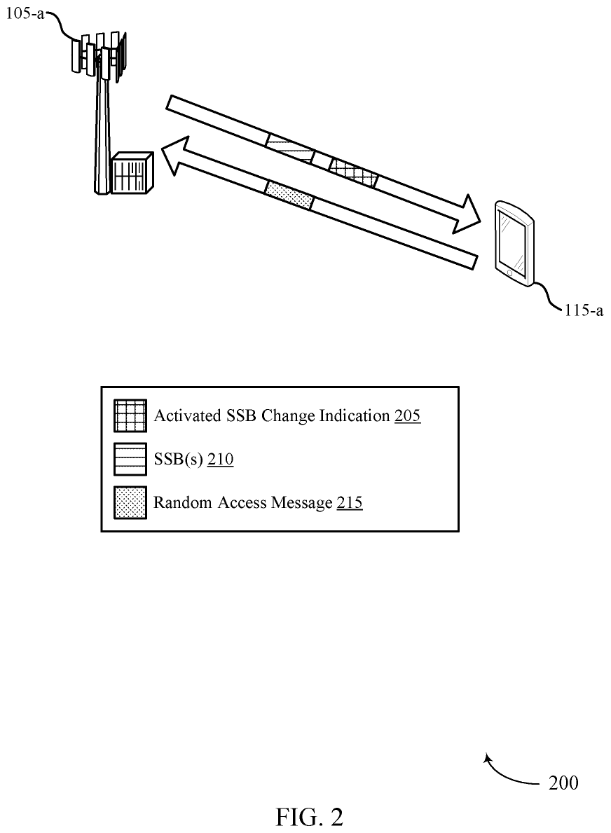

FIG. 2 shows an example of a wireless communications system 200 that supports adaptive SSB occasion to RO mapping in accordance with one or more aspects of the present disclosure. In some cases, aspects of the wireless communications system 200 may implement or be implemented by aspects of FIG. 1. For example, the wireless communications system 200 may include a network entity 105-a and a UE 115-a, which may be examples of network entities 105 and UEs 115, respectively, as described herein with respect to FIG. 1. In some aspects, the UE 115-a may receive signaling that includes an activated SSB change indication 205 (e.g., an indication of a change in a quantity of activated SSB occasions of a plurality of SSB occasions within an SSB burst) and may transmit a random access message 215 based on an adaptive mapping of SSB occasions to ROs based on the activated SSB change indication 205.

In some cases, the wireless communications system 200 may support mechanisms to update a periodicity of SSB occasions (e.g., how often SSBs are transmitted). In some cases, the mechanism may not allow for updating the periodicity of SSB occasions dynamically (e.g., aperiodically, based on one or more aperiodic factors). For example, the network entity 105-a may transmit a SIB (e.g., SIB1) that includes an indication of the updated SSB occasion periodicity. In some cases, the network entity 105-a may update the periodicity of the SSB occasions (e.g., adapting the SSB occasions in a time domain) to reduce energy consumption at the network entity 105-a and at the UE 115-a. For example, the network entity 105-a may save power via transmitting SSBs less frequently, and the UE 115-a may save power via monitoring for SSBs less frequently.

In some cases, the UE 115-a may receive control signaling (e.g., SIB1) from the network entity 105-a, which may include one or more information elements (IEs). In some cases, the one or more IEs may include SSB-PositionInBurst, which may include a bitmap that informs the UE 115-a of which SSB occasions of a plurality of SSB occasions within an SSB burst are activated SSB occasions (e.g., which SSBs in the SSB burst will actually be transmitted). In some cases, the bitmap may impact multiple operations at the UE 115-b. For example, the UE 115-a may use a mapping of SSB occasions to ROs that is based on the bitmap to select an RO for transmitting a random access message based on the SSBs transmitted within the activated SSB occasions. In some cases, the SSB occasion to RO mapping may map activated SSB occasions to respective ROs (e.g., and may not map deactivated SSB occasions to respective ROs).

In some cases, adapting a quantity of activated SSB occasions (e.g., indicated by SSB-PositionsInBurst) may also save power in the wireless communications system. However, in some wireless communications systems (e.g., other than the wireless communications system 200), adapting the quantity of activated SSB occasions may lead to an unclear mapping between the activated SSB occasions and the plurality of ROs. For example, if the adaptation to the quantity of activated SSB occasions (e.g., to SSB-PositionInBurst) adds more activated SSB occasions, a UE may not know which RO (e.g., if any) of a plurality of ROs with which to associate the added activated SSB occasions. Additionally, or alternatively, if the adaptation to the quantity of activated SSB occasions removes activated SSB occasions (e.g., deactivates SSB occasions), the UE may not know how to use (e.g., if at all) an RO of the plurality of ROs that was mapped to the removed (e.g., deactivated) SSB occasions. Thus, the techniques described herein may include an adaptive SSB occasions to RO mapping (e.g., SSB occasion to RO mapping) to handle a dynamic quantity of activated SSB occasions within an SSB burst.

To dynamically indicate the change in the quantity of activated SSB occasions, the UE 115-a may receive the activated SSB change indication 205 from the network entity 105-a. In some cases, the network entity 105-a may transmit the activated SSB change indication 205 via control signaling, including RRC signaling, SIB signaling, medium access control (MAC) signaling, downlink control information (DCI) signaling, or any combination thereof. Additionally, or alternatively, the network entity 105-a may transmit the activated SSB change indication 205 dynamically, semi-statically, or periodically. The UE 115-b may monitor one or more activated SSB occasions based on the activated SSB change indication 205, and may measure one or more SSBs 210 received from the network entity 105-a via the activated SSB occasions. In some cases, the UE 115-a may select an RO from a plurality of ROs based on an adaptive SSB occasion to RO mapping and the measurements of the one or more SSBs 210. The UE 115-a may transmit a random access message 215 via the selected RO. Thus, the network entity 105-a and the UE 115-a may save power via dynamically changing activated SSB occasions without negatively affecting the ability of the UE 115-a to select an RO for the random access message 215.

In some aspects, FIGS. 3 and 4 may describe various examples of adapting (e.g., updating) the SSB occasion to RO mapping (e.g., the mapping) based on the activated SSB change indication 205. For example, the network entity 105-a or the UE 115-a may adapt the mapping. In some cases, adapting the mapping may occur after a time duration elapses from reception of the activated SSB change indication 205 at the UE 115-a.

In some examples, the time duration may include a fixed time duration. For example, the time duration may include a quantity of frames, slots, symbols, milliseconds, or other periods, which may be defined in one or more standards documents. In some other examples, the time duration may include a dynamic time duration. For example, the UE 115-a may receive an indication of the time duration via RRC signaling (e.g., from the network entity 105-a), via the signaling that includes the activated SSB change indication 205, or both. In yet other examples, the time duration may elapse when the UE 115-a receives a SIB (e.g., SIB1) after reception of the activated SSB change indication 205. For example, the SIB may include a temporally next SIB after reception of the activated SSB change indication 205 at the UE 115-a. In an example, when the UE 115-a receives an indication adapting the SSB-PositionInBurst, the UE 115-a may not make any assumptions about a change in the SSB-RO mapping until the fixed time duration elapses, or an indicated time that is either RRC configured or indicated with the dynamic adaptation elapses, or until a next SIB1 is received.

FIG. 3 shows an example of a resource correspondence diagram 300 that supports adaptive SSB occasion to RO mapping in accordance with one or more aspects of the present disclosure. In some cases, aspects of the resource correspondence diagram 300 may implement or be implemented by aspects of FIGS. 1 and 2. For example, the resource correspondence diagram 300 may include SSB occasions 305 and ROs 310, which may be examples of the SSB occasions and ROs, respectively, as described herein with respect to FIGS. 1 and 2. In some aspects, the resource correspondence diagram 300 may illustrate various examples for adapting an SSB occasion to RO mapping based on a change 315 (e.g., a decrease) in a quantity of a plurality of activated SSB occasions within an SSB burst 320-b. Although quantities (e.g., four) of SSB occasions 305 and ROs 310 are shown in the resource correspondence diagram 300, any quantity of SSB occasions 305 and any quantity of ROs 310 may be anticipated by the present disclosure, as well as any mapping between SSB occasions 305 and ROs 310.

In the context of the resource correspondence diagram 300, a UE 115 (e.g., not shown) may receive an indication of the change 315 (e.g., such as the activated SSB change indication 205), which may include deactivating an SSB occasion of the SSB burst 320-a, such as the SSB occasion 305-c (e.g., adapting SSB-PositionInBurst such that one or more SSBs (e.g., one or more SSB indices) are no longer transmitted in the SSB burst 320-b). In some cases, the SSB burst 320-a may occur at a first time before the change 315, and an SSB burst 320-b may occur at a second time after the change 315. For example, before the change 315, an SSB occasion to RO mapping (e.g., the mapping) may associate an SSB occasion 305-a with an RO 310-a, an SSB occasion 305-b with an RO 310-b, the SSB occasion 305-c with an RO 310-c, and an SSB occasion 305-d with an RO 310-d. After the change 315 (e.g., and possibly after the time duration elapses, as described herein with respect to FIG. 2), the mapping may adapt based on the change 315.

Based on the change 315 (e.g., a decrease in the quantity of activated SSB occasions), the mapping may adapt in various ways. In some examples, according to the mapping (e.g., the adapted mapping), the UE 115 may not use (e.g., may not select, may not consider for selection) the RO 310-c, which may have corresponded to the SSB occasion 305-c (e.g., corresponding to the SSB that is not being transmitted) previous to the change 315. In some cases, the UE 115 may, according to the mapping, still consider the RO 310-c as valid, for example, to avoid altering the mapping with respect to the other SSB occasions 305.

In some other example, according to the mapping, the UE 115 may use the RO 310-c, which may have corresponded to the SSB occasion 305-c previous to the change 315. For example, the mapping may associate the RO 310-c with an SSB occasion 305 that is associated with an RO 310 that occurs before or after (e.g., immediately and temporally before or after) the RO 310-c. For example, in the case of the resource correspondence diagram 300, the mapping may associate the RO 310-c with an SSB occasion 305 associated with the RO 310-b or the RO 310-d (e.g., the SSB occasion 305-b or the SSB occasion 305-d, respectively). In some cases, the mapping may associate the RO 310-c with the later SSB occasion 305 (e.g., SSB occasion 305-d) to reduce latency associated with the UE 115 waiting for the RO 310-d to transmit a random access message associated with the SSB occasion 305-d.

As another example of using the RO 310-c, the mapping may associate the RO 310-c with the SSB occasion 305-c (e.g., which may be deactivated according to the change 315). For example, the UE 115 may have performed measurements on SSBs received via the SSB occasion 305-c during another SSB burst previous to the SSB burst 320-a (e.g., not shown). Accordingly, the UE 115 may select the RO 310-c for transmission of the random access message based on the previous measurements associated with the SSB occasion 305-c.

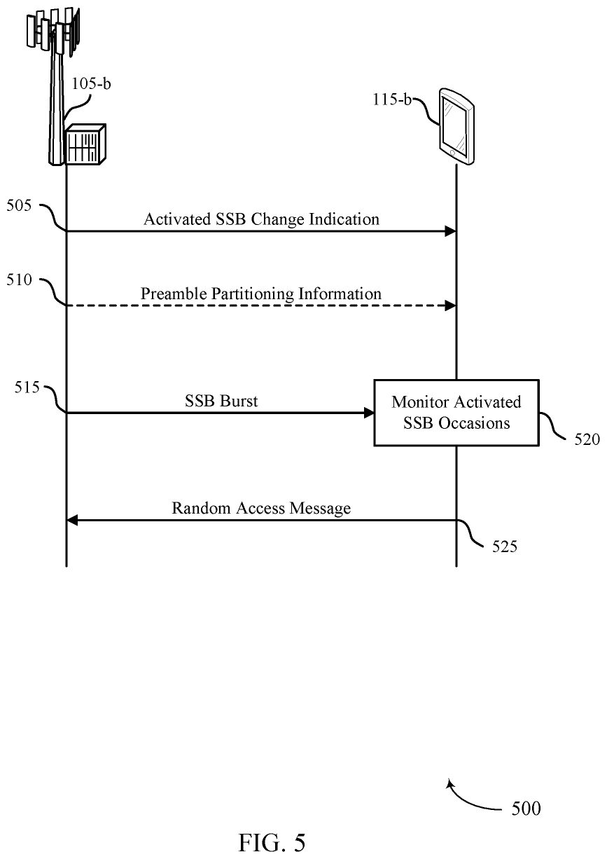

In yet other examples, according to the mapping, the RO 310-c may be deemed invalid (e.g., an invalid RO) based on deactivation of the associated SSB occasion 305-c according to the change 315. That is, the UE 115 may exclude the RO 310-c from a set of ROs 310 from which the UE 115 selects an RO 310 for transmission of the random access message based on the change 315. In some cases, deeming the RO 310-c as invalid may impact a previous mapping (e.g., from before the change 315). For example, one or more UEs 115 (e.g., legacy UEs) may not be capable of dynamically adapting the mapping as described herein, and thus there may exist an inconsistency between mappings for different UEs 115 (e.g., between new UEs and legacy UEs). However, the UEs 115 may ignore the inconsistency (e.g., without experiencing a negative effect), or the UEs 115 may utilize preamble partitioning (e.g., as described herein with respect to FIGS. 4 and 5) to mitigate the effects of the inconsistency.

FIG. 4 shows an example of a resource correspondence diagram 400 that supports adaptive SSB occasion to RO mapping in accordance with one or more aspects of the present disclosure. In some cases, aspects of the resource correspondence diagram 400 may implement or be implemented by aspects of FIGS. 1-3. For example, the resource correspondence diagram 400 may include SSB occasions 405 and ROs 410, which may be examples of SSB occasions 305 and ROs 310, respectively, as described herein with respect to FIGS. 1-3. In some aspects, the resource correspondence diagram 400 may illustrate various examples for adapting an SSB occasion to RO mapping (e.g., the mapping) based on a change 415 (e.g., an increase) in a quantity of a plurality of activated SSB occasions within an SSB burst 420-b. Although quantities (e.g., four) of SSB occasions 405 and ROs 410 are shown in the resource correspondence diagram 400, any quantity of SSB occasions 405 and any quantity of ROs 410 may be anticipated by the present disclosure, as well as any mapping between SSB occasions 405 and ROs 410.

In the context of the resource correspondence diagram 400, a UE 115 (e.g., not shown) may receive an indication of the change 315 (e.g., such as the activated SSB change indication 205), which may include activating an SSB occasion of an SSB burst 420-a, such as the SSB occasion 305-c (e.g., adapting SSB-PositionInBurst such that some SSBs (e.g., SSB indices) are transmitted in the SSB burst 420-b), where SSB transmission did not occur within the SSB occasion 305-c prior to the change. In some cases, the SSB burst 420-a may occur at a first time before the change 415, and an SSB burst 420-b may occur at a second time after the change 415. For example, before the change 415, an SSB occasion to RO mapping (e.g., the mapping) may associate an SSB occasion 405-a with an RO 410-a and an RO 410-d, an SSB occasion 405-b with an RO 410-b, and an SSB occasion 405-d with an RO 410-c. After the change 415 (e.g., and possibly after the time duration elapses, as described herein with respect to FIG. 2), the mapping may adapt based on the change 415.

Based on the change 415 (e.g., an increase in the quantity of activated SSB occasions), the mapping may adapt in various ways. In some examples, according to the mapping (e.g., the adapted mapping), the SSB occasion 405-c of the SSB burst 420-b may not be associated with an RO 410. For example, the mapping may be the same before and after the change 415, such that no RO 410 may be associated with the SSB occasion 405-c in the SSB burst 420-b. Accordingly, the UE 115 may not transmit a random access message of a random access channel (RACH) procedure associated with the SSB occasion 405-c of the SSB burst 420-b.

In some other examples, the UE 115 may update (e.g., redo, adapt) the mapping based on the change 415. For example, the UE 115 may update the mapping such that each activated SSB occasion of the SSB burst 420-b (e.g., SSB occasions 405-a, 405-b, 405-c, and 405-d) are associated with one or more ROs 410, which association may follow any pattern or order. In some cases, the UE 115 may update the mapping after a time duration has elapsed from the change 415 (e.g., from receiving signaling indicating the change 415, as described herein with respect to FIGS. 2 and 5).

In yet other examples, according to the mapping, one or more of the ROs 410 may be associated with multiple SSB occasions 405 of the SSB burst 420-b, including the SSB occasion 405-c (e.g., which may be newly activated based on the change 415). For example, the UE 115 may utilize preamble partitioning to share one or more ROs 410 between the SSB occasion 405-c and another SSB occasion 405. For example, each RO 410 may be associated with a set of preambles, and the UE 115 may select a preamble to attach to the random access message from the set of preambles. According to preamble partitioning, the set of preambles may be divided into two or more subsets (e.g., partitions), where each subset of preambles corresponds to a respective SSB occasion 405. Thus, the UE 115 may transmit the random access message within the RO 410 based on the SSB occasions 405-c that includes a preamble from a first subset of preambles, or based on the other SSB occasion 405 (e.g., SSB occasion 405-b) using a preamble from a second subset of preambles. By transmitting a random access message within the RO 410 that includes a preamble from the first subset of preambles, the UE 115 may be indicating to the network entity 105 that the beam associated with the SSB occasions 405-c is to be used for subsequent communication. Additionally, by transmitting a random access message within the RO 410 that includes a preamble from the second subset of preambles, the UE 115 may be indicating to the network entity 105 that the beam associated with the other SSB occasions 405 (e.g., SSB occasion 405-b) is to be used for subsequent communication.

In some cases, a network entity 105 may dynamically indicate the other SSB occasion 405 (e.g., that may share the RO 410 with the SSB occasion 405-c) to the UE 115, or the network entity 105 may indicate the other SSB occasion 405 to the UE 115 via RRC signaling (e.g., as described herein with respect to FIG. 5 at 410). In some cases, the other SSB occasion 405 may be based on an index of the SSB occasion 405 that is activated based on the change 415 (e.g., SSB occasion 405-c). For example, the other SSB occasion 405 may include an SSB occasion 405 that is temporally next to the activated SSB occasion within the SSB burst 420-b. In some case, the selected SSB index that may share ROs with the newly added SSB can be either dynamically indicated or RRC configured by the network entity 105. The selected SSB index that may share ROs with the newly added SSB may depend on the index of the added SSB occasion.

FIG. 5 shows an example of a process flow 500 that supports adaptive SSB occasion to RO mapping in accordance with one or more aspects of the present disclosure. In some cases, aspects of the process flow 500 may implement or be implemented by aspects of FIGS. 1-4. For example, the process flow 500 may include a network entity 105-b and a UE 115-b, which may be examples of the network entities 105 and the UEs 115, respectively, as described herein with respect to FIGS. 1-4. In some aspects, the UE 115-a may transmit a random access message based on an adaptive SSB occasion to RO mapping.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UE 115-b and the network entity 105-b are shown performing the operations of process flow 500, some aspects of some operations may also be performed by one or more other wireless devices or network devices.

At 505, the UE 115-b may receive signaling indicating a change in a quantity of a plurality of activated SSB occasions within an SSB burst associated with the network entity 105-b (e.g., the activated SSB change indication 205 as described herein with respect to FIG. 2). In some cases, an SSB occasion to RO mapping (e.g., a mapping) may indicate (e.g., to the UE 115-b, to the network entity 105-b) that the plurality of activated SSB occasions are respectively mapped to a plurality of ROs based on the signaling. For example, the UE 115-b may adapt the mapping based on the change (e.g., at a time described herein), the mapping may be defined in one or more standards documents according to the change in the quantity of the plurality of activated SSB occasions (e.g., whether the quantity increases or decreases, which SSB occasion was activated or deactivates), the network entity 105-b may indicate the mapping to the UE 115-b (e.g., via control signaling), or any combination thereof.

In some cases, the change in the quantity of the plurality of activated SSB occasions may include decreasing the quantity (e.g., as described herein with respect to FIG. 3). For example, the signaling may indicate that a first SSB occasion of the plurality of SSB occasions is newly deactivated (e.g., may indicate to deactivate the first SSB occasion). If the change includes decreasing the quantity, the mapping may adapt in one or more of the following ways.

In some examples, the mapping may indicate that the first SSB occasion (e.g., newly activated according to the signaling) is mapped to one of the plurality of ROs based on the signaling. Additionally, or alternatively, the mapping may indicate that an RO that was mapped to the first SSB occasion (e.g., prior to the deactivation of the first SSB occasion) is mapped to a second SSB occasion of the plurality of activated SSB occasions. For example, the second SSB occasion may be temporally adjacent to the deactivated first SSB occasion within the SSB burst, or the signaling may indicate the second SSB occasion. Additionally, or alternatively, the mapping may indicate that the RO corresponds to the first SSB occasion. For example, the UE 115-b may have previously monitored the first SSB occasion (e.g., within another SSB burst that may occur prior to deactivation of the first SSB occasion), and the UE 115-b may eventually select the first SSB occasion for transmitting a random access message (e.g., at 425) based on previously monitoring the first SSB occasion. Additionally, or alternatively, the mapping may exclude an RO of the plurality of ROs that corresponds to the first SSB occasion based on the signaling.

In some cases, the change in the quantity of the plurality of activated SSB occasions may include increasing the quantity (e.g., as described herein with respect to FIG. 4). For example, the signaling may indicate that a first SSB occasion of the plurality of SSB occasions is newly activated (e.g., may indicate to activate the first SSB occasion). If the change includes increasing the quantity, the mapping may adapt in one or more of the following ways.

In some examples, the mapping (e.g., the adapted mapping) may associate (e.g., map, correspond) each of the plurality of activated SSB occasions except for the first SSB occasion (e.g., newly activated) with one or more respective ROs of the plurality of ROs. Additionally, or alternatively, the mapping may associate each of the plurality of activated SSB occasions including the activated first SSB occasion with one or more respective ROs of the plurality of ROs based on the signaling. Additionally, or alternatively, the UE 115-b may associate the activated first SSB occasion and a second SSB occasion of the plurality of activated SSB occasions with an RO of the plurality of ROs (e.g., via preamble partitioning, as described herein with respect to FIG. 2). For example, if the UE 115-b selects the RO associated with the first SSB occasion and the second SSB occasion for transmitting the random access message, a preamble of the random access message may correspond to either the first SSB occasion or the second SSB occasion. For example, the random access message may include a first preamble of a first subset of preambles of a plurality of preambles associated with the RO, wherein the first subset of preambles may correspond to the activated first SSB occasion. In some cases, a second subset of preambles of the plurality of preambles may correspond to the second SSB occasion of the plurality of activated SSB occasions.

In some cases, the UE 115-b may apply (e.g., obtain, adapt) the mapping to operations of the UE 115-b based on a time duration from reception of the signaling (e.g., at 505) elapsing (e.g., as described herein with respect to FIG. 2). In some cases, the time duration may be fixed (e.g., a fixed time duration, defined in one or more standards documents). Additionally, or alternatively, the network entity 105-b may indicate the time duration to the UE via the signaling at 505. Additionally, or alternatively, the network entity 105-b may indicate the time duration to the UE via RRC signaling. In some cases, the UE 115-b may receive a SIB after reception of the signaling, and the mapping may be applied based on (e.g., upon, after) reception of the SIB. For example, the time duration may elapse based on reception of the SIB.

At 510 (e.g., if the UE 115-b uses preamble partitioning due to, for example, the quantity increasing), the UE 115-b may receive second signaling indicating preamble partitioning information. For example, the second signaling may indicate the second SSB occasion of the plurality of activated SSB occasions with which a newly activated first SSB occasion may share an RO of the plurality of ROs. For example, the activated first SSB occasion may be associated with the first subset of preambles and the second SSB occasion may be associated with the second subset of preambles, as described herein at 405. Additionally, or alternatively, the preamble partitioning information may indicate one or more preambles that may be included in the first subset, one or more preambles that may be included in the second subset, or both.

At 515, the network entity 105-b may transmit the SSB burst. For example, the network entity 105-b may transmit one or more SSBs within the plurality of activated SSB occasions (e.g., as indicated by the signaling at 505).

At 520, the UE 115-b may monitor the plurality of activated SSB occasions of the plurality of SSB occasions of the SSB burst based on the signaling (e.g., of 505). For example, the UE 115-b may determine which of the plurality of SSB occasions are activated SSB occasions based on the signaling, and may adjust one or more receiving antennas of the UE 115-b to attempt to receive the SSBs via the activate SSB occasions of the SSB burst. In some cases, the UE 115-b may perform one or more measurements (e.g., reference signal receive power (RSRP) measurements, received signal strength indicator (RSSI) measurements, received power measurements) of the one or more SSBs of the SSB burst.

At 525, the UE 115-b may transmit the random access message via an RO based on monitoring the plurality of activated SSB occasions, and based on the mapping. For example, the UE 115-b may select an RO of the plurality of ROs for transmitting a random access message based on the one or more measurements. For example, the UE 115-b may select an RO mapped to an SSB occasion associated with the highest measurement.

Thus, according to the techniques described herein, a UE 115-b may save power via monitoring fewer SSB occasions (e.g., the plurality of activated SSB occasions) based on an adaptive SSB occasion to RO mapping. Additionally, or alternatively, the network entity 105-b may save energy by transmitting less SSBs based on the adaptive SSB occasion to RO mapping.

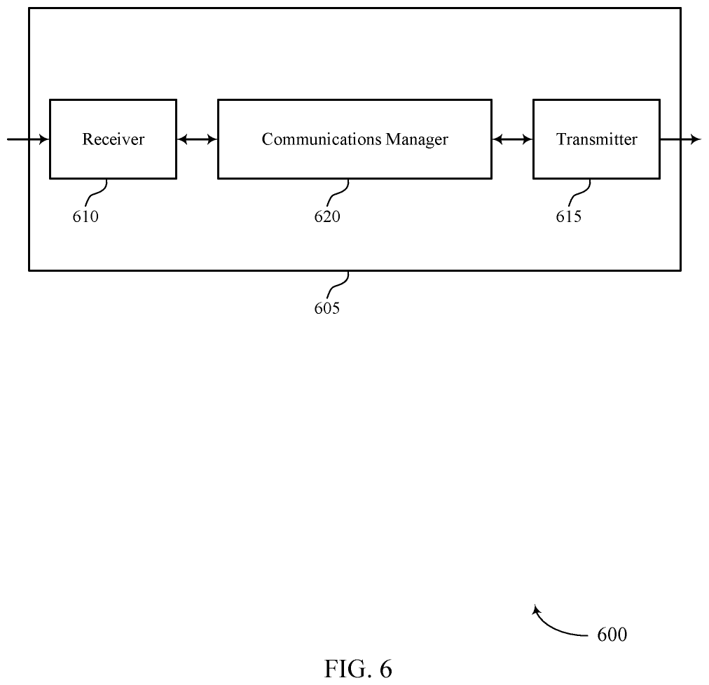

FIG. 6 shows a block diagram 600 of a device 605 that supports adaptive SSB occasion to RO mapping in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to adaptive SSB occasion to RO mapping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to adaptive SSB occasion to RO mapping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of adaptive SSB occasion to RO mapping as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving signaling indicating a change in a quantity of a set of multiple activated SSB (SSB) occasions of a set of multiple SSB occasions of an SSB burst, where a mapping indicates that the set of multiple activated SSB occasions are respectively mapped to a set of multiple ROs based on the signaling. The communications manager 620 is capable of, configured to, or operable to support a means for monitoring the set of multiple activated SSB occasions of the set of multiple SSB occasions of the SSB burst based on the signaling. The communications manager 620 is capable of, configured to, or operable to support a means for transmitting a random access message via a RO of the set of multiple ROs based on the set of multiple activated SSB occasions being monitored and the mapping.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources. For example, a UE 115 implementing the techniques described herein may monitor fewer SSB occasions without experiencing a negative effect on the SSB occasion to RO mapping, which may save power and communication resources at the UE 115.

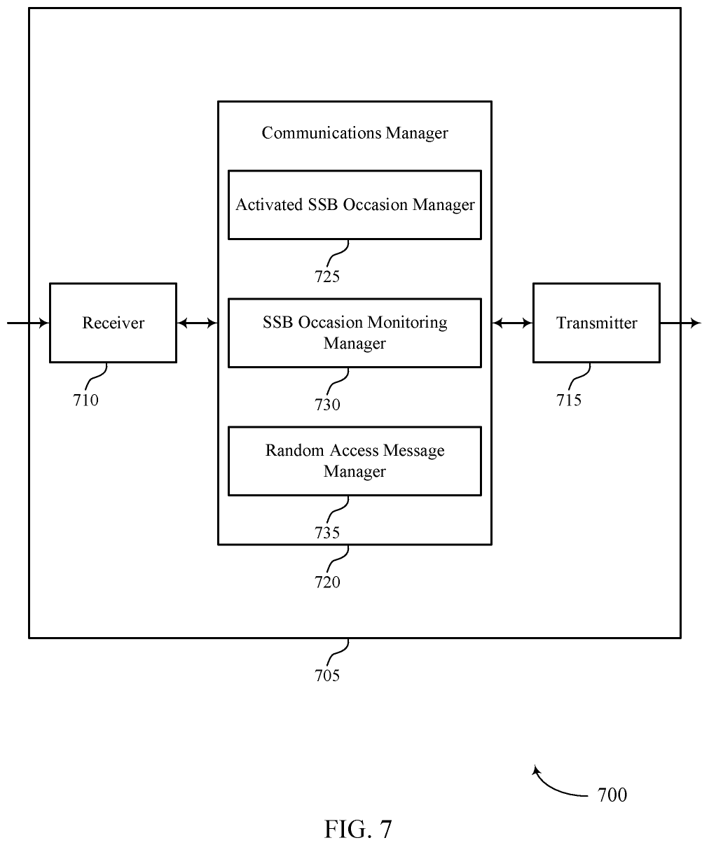

FIG. 7 shows a block diagram 700 of a device 705 that supports adaptive SSB occasion to RO mapping in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptive SSB occasion to RO mapping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptive SSB occasion to RO mapping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of adaptive SSB occasion to RO mapping as described herein. For example, the communications manager 720 may include an activated SSB occasion manager 725, an SSB occasion monitoring manager 730, a random access message manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The activated SSB occasion manager 725 is capable of, configured to, or operable to support a means for receiving signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling. The SSB occasion monitoring manager 730 is capable of, configured to, or operable to support a means for monitoring the set of multiple activated SSB occasions of the set of multiple SSB occasions of the SSB burst based on the signaling. The random access message manager 735 is capable of, configured to, or operable to support a means for transmitting a random access message via a RO of the set of multiple ROs based on the set of multiple activated SSB occasions being monitored and the mapping.

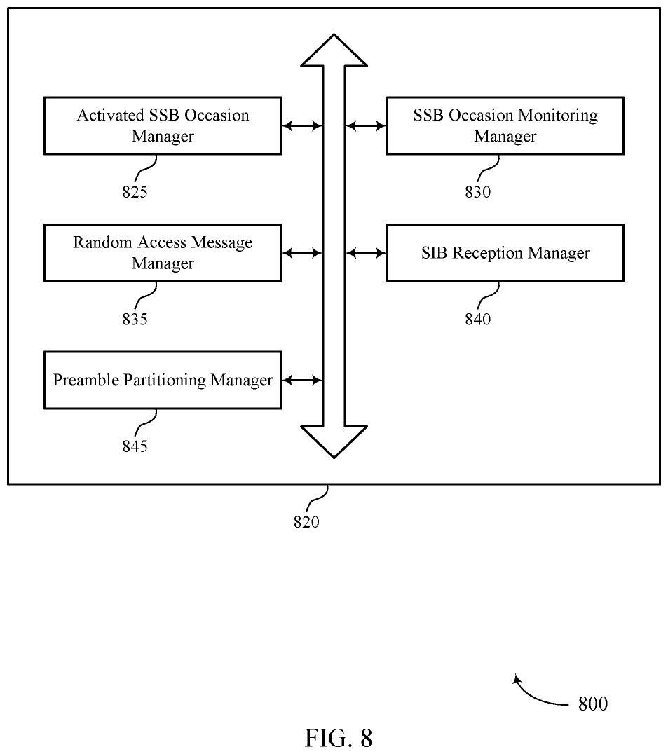

FIG. 8 shows a block diagram 800 of a communications manager 820 that supports adaptive SSB occasion to RO mapping in accordance with one or more aspects of the present disclosure. The communications manager 820 may be an example of aspects of a communications manager 620, a communications manager 720, or both, as described herein. The communications manager 820, or various components thereof, may be an example of means for performing various aspects of adaptive SSB occasion to RO mapping as described herein. For example, the communications manager 820 may include an activated SSB occasion manager 825, an SSB occasion monitoring manager 830, a random access message manager 835, an SIB reception manager 840, a preamble partitioning manager 845, or any combination thereof. Each of these components, or components or subcomponents thereof (e.g., one or more processors, one or more memories), may communicate, directly or indirectly, with one another (e.g., via one or more buses).

The activated SSB occasion manager 825 is capable of, configured to, or operable to support a means for receiving signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling. The SSB occasion monitoring manager 830 is capable of, configured to, or operable to support a means for monitoring the set of multiple activated SSB occasions of the set of multiple SSB occasions of the SSB burst based on the signaling. The random access message manager 835 is capable of, configured to, or operable to support a means for transmitting a random access message via a RO of the set of multiple ROs based on the set of multiple activated SSB occasions being monitored and the mapping.

In some examples, the signaling indicates to deactivate a first SSB occasion of the set of multiple activated SSB occasions. In some examples, the mapping indicates that the first SSB occasion is mapped to one of the set of multiple ROs based on the signaling.

In some examples, the signaling indicates to deactivate a first SSB occasion of the set of multiple activated SSB occasions. In some examples, the mapping indicates that the RO is mapped to a second SSB occasion of the set of multiple activated SSB occasions that is temporally adjacent to the deactivated first SSB occasion within the SSB burst based on the signaling.

In some examples, the signaling indicates to deactivate a first SSB occasion of the set of multiple activated SSB occasions. In some examples, the mapping indicates that the RO corresponds to the first SSB occasion, the first SSB occasion being monitored within a second SSB burst that occurs prior to deactivation of the first SSB occasion.

In some examples, the signaling indicates to deactivate a first SSB occasion of the set of multiple activated SSB occasions. In some examples, the mapping excludes a second RO of the set of multiple ROs that corresponds to the first SSB occasion based on the signaling.

In some examples, the signaling indicates to activate a first SSB occasion of the set of multiple SSB occasions. In some examples, the mapping associates each of the set of multiple activated SSB occasions except for the activated first SSB occasion with a respective RO of the set of multiple ROs based on the signaling.

In some examples, the signaling indicates to activate a first SSB occasion of the set of multiple SSB occasions. In some examples, the mapping associates each of the set of multiple activated SSB occasions including the activated first SSB occasion with a respective RO of the set of multiple ROs based on the signaling.

In some examples, the signaling indicates to activate a first SSB occasion of the set of multiple SSB occasions. In some examples, the random access message includes a first preamble of a first subset of preambles of a set of multiple preambles associated with the RO. In some examples, the first subset of preambles corresponds to the activated first SSB occasion and a second subset of preambles of the set of multiple preambles corresponds to a second SSB occasion of the set of multiple activated SSB occasions.

In some examples, the preamble partitioning manager 845 is capable of, configured to, or operable to support a means for receiving second signaling indicating the second SSB occasion of the set of multiple activated SSB occasions is associated with preamble partitioning of the set of multiple preambles.

In some examples, the mapping is based on a time duration from reception of the signaling elapsing. In some examples, the time duration is a fixed time duration, is indicated to the UE via the received signaling, is indicated to the UE via RRC signaling, or any combination thereof.

In some examples, the SIB reception manager 840 is capable of, configured to, or operable to support a means for receiving a system information block after reception of the signaling, where the mapping is applied based on reception of the system information block.

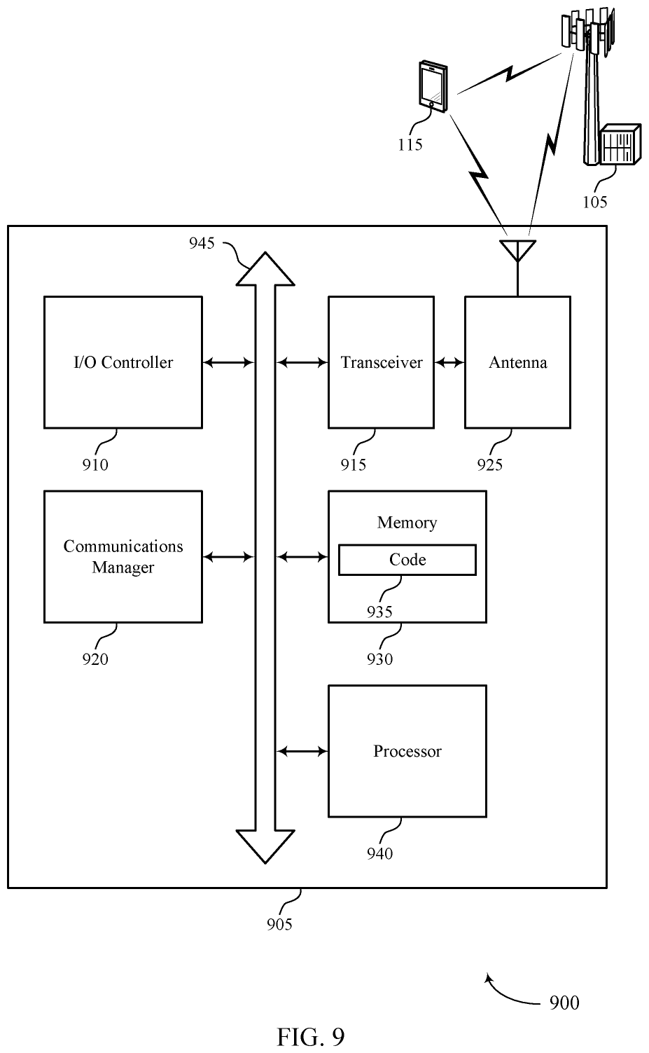

FIG. 9 shows a diagram of a system 900 including a device 905 that supports adaptive SSB occasion to RO mapping in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting adaptive SSB occasion to RO mapping). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

For example, the communications manager 920 is capable of, configured to, or operable to support a means for receiving signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling. The communications manager 920 is capable of, configured to, or operable to support a means for monitoring the set of multiple activated SSB occasions of the set of multiple SSB occasions of the SSB burst based on the signaling. The communications manager 920 is capable of, configured to, or operable to support a means for transmitting a random access message via a RO of the set of multiple ROs based on the set of multiple activated SSB occasions being monitored and the mapping.

By including or configuring the communications manager 920 in accordance with examples as described herein, the device 905 may support techniques for reduced power consumption and improved coordination between devices. For example, a UE 115 implementing the techniques described herein may monitor fewer SSB occasions without experiencing a negative effect on the SSB occasion to RO mapping, which may save power by improving coordination between the UE 115 and a network entity 105.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of adaptive SSB occasion to RO mapping as described herein, or the at least one processor 940 and the at least one memory 930 may be otherwise configured to, individually or collectively, perform or support such operations.

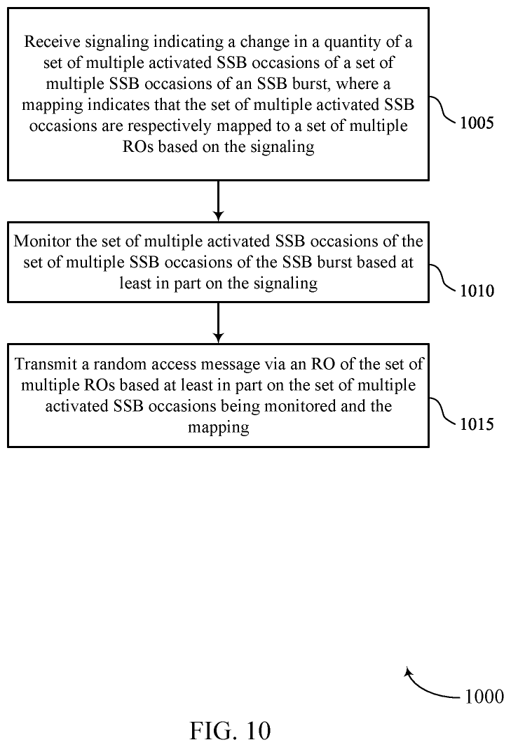

FIG. 10 shows a flowchart illustrating a method 1000 that supports adaptive SSB occasion to RO mapping in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving signaling indicating a change in a quantity of a set of multiple activated SSB occasions of a set of multiple SSB occasions of an SSB burst, where a mapping indicates that the set of multiple activated SSB occasions are respectively mapped to a set of multiple ROs based on the signaling. The operations of 1005 may be performed in accordance with examples as disclosed herein. In some examples, aspects of the operations of 1005 may be performed by an activated SSB occasion manager 825 as described with reference to FIG. 8.

At 1010, the method may include monitoring the set of multiple activated SSB occasions of the set of multiple SSB occasions of the SSB burst based at least in part on the signaling. The operations of 1010 may be performed in accordance with examples as disclosed herein. In some examples, aspects of the operations of 1010 may be performed by an SSB occasion monitoring manager 830 as described with reference to FIG. 8.

At 1015, the method may include transmitting a random access message via a RO of the set of multiple ROs based at least in part on the set of multiple activated SSB occasions being monitored and the mapping. The operations of 1015 may be performed in accordance with examples as disclosed herein. In some examples, aspects of the operations of 1015 may be performed by a random access message manager 835 as described with reference to FIG. 8.

The following provides an overview of aspects of the present disclosure:

Aspect 1: A method for wireless communications at a UE, comprising: receiving signaling indicating a change in a quantity of a plurality of activated SSB occasions of a plurality of SSB occasions of an SSB burst, wherein a mapping indicates that the plurality of activated SSB occasions are respectively mapped to a plurality of ROs based at least in part on the signaling; monitoring the plurality of activated SSB occasions of the plurality of SSB occasions of the SSB burst based at least in part on the signaling; and transmitting a random access message via a RO of the plurality of ROs based at least in part on the plurality of activated SSB occasions being monitored and the mapping.

Aspect 2: The method of aspect 1, wherein the signaling indicates to deactivate a first SSB occasion of the plurality of activated SSB occasions, and the mapping indicates that the first SSB occasion is mapped to one of the plurality of ROs based at least in part on the signaling.

Aspect 3: The method of any of aspects 1 through 2, wherein the signaling indicates to deactivate a first SSB occasion of the plurality of activated SSB occasions, and the mapping indicates that the RO is mapped to a second SSB occasion of the plurality of activated SSB occasions that is temporally adjacent to the deactivated first SSB occasion within the SSB burst based at least in part on the signaling.

Aspect 4: The method of any of aspects 1 through 2, wherein the signaling indicates to deactivate a first SSB occasion of the plurality of activated SSB occasions, and the mapping indicates that the RO corresponds to the first SSB occasion, the first SSB occasion being monitored within a second SSB burst that occurs prior to deactivation of the first SSB occasion.

Aspect 5: The method of aspect 1, wherein the signaling indicates to deactivate a first SSB occasion of the plurality of activated SSB occasions, and the mapping excludes a second RO of the plurality of ROs that corresponds to the first SSB occasion based at least in part on the signaling.

Aspect 6: The method of aspect 1, wherein the signaling indicates to activate a first SSB occasion of the plurality of SSB occasions, and the mapping associates each of the plurality of activated SSB occasions except for the activated first SSB occasion with a respective RO of the plurality of ROs based at least in part on the signaling.

Aspect 7: The method of aspect 1, wherein the signaling indicates to activate a first SSB occasion of the plurality of SSB occasions, and the mapping associates each of the plurality of activated SSB occasions including the activated first SSB occasion with a respective RO of the plurality of ROs based at least in part on the signaling.

Aspect 8: The method of any of aspects 1 and 7, wherein the signaling indicates to activate a first SSB occasion of the plurality of SSB occasions, the random access message comprises a first preamble of a first subset of preambles of a plurality of preambles associated with the RO, and the first subset of preambles corresponds to the activated first SSB occasion and a second subset of preambles of the plurality of preambles corresponds to a second SSB occasion of the plurality of activated SSB occasions.

Aspect 9: The method of aspect 8, further comprising: receiving second signaling indicating the second SSB occasion of the plurality of activated SSB occasions is associated with preamble partitioning of the plurality of preambles.

Aspect 10: The method of any of aspects 1 through 9, wherein the mapping is based at least in part on a time duration from reception of the signaling elapsing, and the time duration is a fixed time duration, is indicated to the UE via the received signaling, is indicated to the UE via RRC signaling, or any combination thereof.

Aspect 11: The method of any of aspects 1 through 10, further comprising: receiving a SIB after reception of the signaling, wherein the mapping is applied based at least in part on reception of the SIB.

Aspect 12: A UE comprising one or more memories storing processor-executable code, and one or more processors coupled with the one or more memories and individually or collectively operable to execute the code to cause the UE to perform a method of any of aspects 1 through 11.

Aspect 13: A UE comprising at least one means for performing a method of any of aspects 1 through 11.

Aspect 14: A non-transitory computer-readable medium storing code the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus at a user equipment (UE), comprising:
at least one processor; and
at least one memory coupled with the at least one processor, with instructions stored in the at least one memory, the instructions being executable by the at least one processor, individually or in any combination, to cause the apparatus to:
receive signaling indicating a change in a quantity of a plurality of activated synchronization signal block (SSB) occasions of a plurality of SSB occasions of an SSB burst, wherein a mapping indicates that the plurality of activated SSB occasions are respectively mapped to a plurality of random access occasions based at least in part on the signaling;
monitor the plurality of activated SSB occasions of the plurality of SSB occasions of the SSB burst based at least in part on the signaling; and
transmit a random access message via a random access occasion of the plurality of random access occasions based at least in part on the plurality of activated SSB occasions being monitored and the mapping.

2. The apparatus of claim 1, wherein the signaling indicates to deactivate a first SSB occasion of the plurality of activated SSB occasions, and wherein the mapping indicates that the first SSB occasion is mapped to one of the plurality of random access occasions based at least in part on the signaling.

3. The apparatus of claim 1, wherein the signaling indicates to deactivate a first SSB occasion of the plurality of activated SSB occasions, and wherein the mapping indicates that the random access occasion is mapped to a second SSB occasion of the plurality of activated SSB occasions that is temporally adjacent to the deactivated first SSB occasion within the SSB burst based at least in part on the signaling.

4. The apparatus of claim 1, wherein the signaling indicates to deactivate a first SSB occasion of the plurality of activated SSB occasions, and wherein the mapping indicates that the random access occasion corresponds to the first SSB occasion, the first SSB occasion being monitored within a second SSB burst that occurs prior to deactivation of the first SSB occasion.

5. The apparatus of claim 1, wherein the signaling indicates to deactivate a first SSB occasion of the plurality of activated SSB occasions, and wherein the mapping excludes a second random access occasion of the plurality of random access occasions that corresponds to the first SSB occasion based at least in part on the signaling.

6. The apparatus of claim 1, wherein the signaling indicates to activate a first SSB occasion of the plurality of SSB occasions, and wherein the mapping associates each of the plurality of activated SSB occasions except for the activated first SSB occasion with a respective random access occasion of the plurality of random access occasions based at least in part on the signaling.

7. The apparatus of claim 1, wherein the signaling indicates to activate a first SSB occasion of the plurality of SSB occasions, and wherein the mapping associates each of the plurality of activated SSB occasions including the activated first SSB occasion with a respective random access occasion of the plurality of random access occasions based at least in part on the signaling.

8. The apparatus of claim 1, wherein the signaling indicates to activate a first SSB occasion of the plurality of SSB occasions, wherein the random access message comprises a first preamble of a first subset of preambles of a plurality of preambles associated with the random access occasion, and wherein the first subset of preambles corresponds to the activated first SSB occasion and a second subset of preambles of the plurality of preambles corresponds to a second SSB occasion of the plurality of activated SSB occasions.

9. The apparatus of claim 8, wherein the instructions are executable by the at least one processor, individually or in any combination, to cause the apparatus to:
receive second signaling indicating the second SSB occasion of the plurality of activated SSB occasions is associated with preamble partitioning of the plurality of preambles.

10. The apparatus of claim 1, wherein the mapping is based at least in part on a time duration from reception of the signaling elapsing, and wherein the time duration is a fixed time duration, is indicated to the UE via the received signaling, is indicated to the UE via radio resource control signaling, or any combination thereof.

11. The apparatus of claim 1, wherein the instructions are executable by the at least one processor, individually or in any combination, to cause the apparatus to:
receive a system information block after reception of the signaling, wherein the mapping is applied based at least in part on reception of the system information block.

12. A method for wireless communications at a user equipment (UE), comprising:
receiving signaling indicating a change in a quantity of a plurality of activated synchronization signal block (SSB) occasions of a plurality of SSB occasions of an SSB burst, wherein a mapping indicates that the plurality of activated SSB occasions are respectively mapped to a plurality of random access occasions based at least in part on the signaling;
monitoring the plurality of activated SSB occasions of the plurality of SSB occasions of the SSB burst based at least in part on the signaling; and
transmitting a random access message via a random access occasion of the plurality of random access occasions based at least in part on the plurality of activated SSB occasions being monitored and the mapping.

13. The method of claim 12, wherein the signaling indicates to deactivate a first SSB occasion of the plurality of activated SSB occasions, and wherein the mapping indicates that the first SSB occasion is mapped to one of the plurality of random access occasions based at least in part on the signaling.

14. The method of claim 12, wherein the signaling indicates to deactivate a first SSB occasion of the plurality of activated SSB occasions, and wherein the mapping indicates that the random access occasion is mapped to a second SSB occasion of the plurality of activated SSB occasions that is temporally adjacent to the deactivated first SSB occasion within the SSB burst based at least in part on the signaling.

15. The method of claim 12, wherein the signaling indicates to deactivate a first SSB occasion of the plurality of activated SSB occasions, and wherein the mapping indicates that the random access occasion corresponds to the first SSB occasion, the first SSB occasion being monitored within a second SSB burst that occurs prior to deactivation of the first SSB occasion.

16. The method of claim 12, wherein the signaling indicates to deactivate a first SSB occasion of the plurality of activated SSB occasions, and wherein the mapping excludes a second random access occasion of the plurality of random access occasions that corresponds to the first SSB occasion based at least in part on the signaling.

17. The method of claim 12, wherein the signaling indicates to activate a first SSB occasion of the plurality of SSB occasions, and wherein the mapping associates each of the plurality of activated SSB occasions except for the activated first SSB occasion with a respective random access occasion of the plurality of random access occasions based at least in part on the signaling.

18. The method of claim 12, wherein the signaling indicates to activate a first SSB occasion of the plurality of SSB occasions, and wherein the mapping associates each of the plurality of activated SSB occasions including the activated first SSB occasion with a respective random access occasion of the plurality of random access occasions based at least in part on the signaling.

19. The method of claim 12, wherein the signaling indicates to activate a first SSB occasion of the plurality of SSB occasions, wherein the random access message comprises a first preamble of a first subset of preambles of a plurality of preambles associated with the random access occasion, and wherein the first subset of preambles corresponds to the activated first SSB occasion and a second subset of preambles of the plurality of preambles corresponds to a second SSB occasion of the plurality of activated SSB occasions.

20. A non-transitory computer-readable medium storing code, the code comprising instructions executable by at least one processor to:
receive signaling indicating a change in a quantity of a plurality of activated synchronization signal block (SSB) occasions of a plurality of SSB occasions of an SSB burst, wherein a mapping indicates that the plurality of activated SSB occasions are respectively mapped to a plurality of random access occasions based at least in part on the signaling;
monitor the plurality of activated SSB occasions of the plurality of SSB occasions of the SSB burst based at least in part on the signaling; and
transmit a random access message via a random access occasion of the plurality of random access occasions based at least in part on the plurality of activated SSB occasions being monitored and the mapping.
